(19) United States
(12) Patent Application Publication
(10) Pub. No.: US 2018/0322977 A1
(43) Pub. Date: Nov. 8, 2018

(54) ANTI-SCATTER FILTER FOR AN X-RAY INSPECTION SYSTEM, X-RAY INSPECTION SYSTEM AND OPERATION OF AN X-RAY INSPECTION SYSTEM

(71) Applicant: YXLON INTERNATIONAL GMBH, Hamburg (DE)

(72) Inventors: Klaus BAVENDIEK, Norderstedt (DE); Uwe HEIKE, Rellingen (DE)

(21) Appl. No.: 15/903,522

(22) Filed: Feb. 23, 2018

(30) Foreign Application Priority Data
May 3, 2017 (DE) 102017109478.4

(51) Int. Cl. G21K 1/02; G01N 23/02

(52) U.S. Cl. CPC G21K 1/025; G01N 2223/313; G01N 23/02

(57) ABSTRACT

The invention relates to an anti-scatter filter 4 for an X-ray inspection system which has an X-ray source 2 with a main beam direction, an X-ray detector 3 and a compartment 16 for introducing an inspection part 5 between X-ray source 2 and X-ray detector 3, wherein the anti-scatter filter 4 is rotatable about an axle 9 which can be driven by a drive motor 10, wherein the axle 9, in the installed state in the X-ray inspection system, is substantially perpendicular to the surface of the X-ray detector 3, wherein the anti-scatter filter 4 has several sheet-like lamellae 12 made of a material that strongly absorbs X-rays, wherein the surfaces of the lamellae 12 are aligned substantially parallel to the main beam direction, wherein the lamellae 12 extend radially out from the axle 9, wherein the lamellae are borne in a common mount 11 at their radially outer ends.

### FIELD OF INVENTION

The invention relates to an anti-scatter filter for an X-ray inspection system which has an X-ray source with a main beam direction, an X-ray detector and a compartment for introducing an inspection part between X-ray source and X-ray detector. The invention also relates to such an X-ray inspection system and the operation of such an X-ray inspection system.

### BACKGROUND OF INVENTION

Unlike useful radiation, which travels substantially in a straight line from the focal spot of an X-ray source to the X-ray detector, scattered radiation is first generated in the inspection part; the inspection part is to be seen as a new radiation source which emits the radiation in all directions. The imaging X-radiation is only the X-radiation which leaves the inspection part in the same direction as the X-radiation entering it; the intensity of this imaging X-radiation is reduced, compared with the X-radiation striking the inspection part, by a factor which depends on the material of the inspection part along the trajectory of the X-radiation penetrating the inspection part. To reduce the non-imaging scattered radiation which forms when the X-radiation passes through the inspection part, it is known to filter out all radiation striking the X-ray detector substantially not perpendicularly—the scattered radiation—by means of anti-scatter grids. The anti-scatter grids are constructed like Venetian blinds from narrow strips of strongly absorbing material (usually lead foil) and more transmissive spacers (usually spacers made of cellulose). The strips are parallel to the X-radiation. The desired directed imaging X-radiation can penetrate the spacer strips, scattered radiation is caught in the lead strips. Such anti-scatter grids have the disadvantage that they leave behind a structure on the X-ray detector. Moreover, they significantly reduce the useful dose that reaches the X-ray detector. Furthermore, the resolution is reduced. In order to limit the reduction in the resolution, the anti-scatter grid used is often rapidly oscillated in order to give beams from all perpendicular directions the chance to strike the X-ray detector. If the anti-scatter grid does not move quickly enough or “sticks” at the reversal points, strips of the grid are imaged on the X-ray image on the X-ray detector. Important parameters for anti-scatter grids in the European Union are defined in the standard DIN EN 60627.

The object of the invention is to provide an alternative to the known anti-scatter grids in which the useful dose is higher. The object also extends to an X-ray inspection system as well as the operation of an X-ray inspection system.

### SUMMARY OF INVENTION

The object is achieved by an anti-scatter filter with the features of claim 1. The main difference between the anti-scatter grids from the state of the art and the anti-scatter filter according to the invention is that the former—as described above—either are stationary or oscillate rapidly, whereas a rotation of the anti-scatter filter is effected in the case of the invention. The rotational movement can be realized by means of a simpler mechanism than the oscillating movement in the case of the oscillating anti-scatter grids known from the state of the art. Moreover, there are no reversal points where the lamellae pause—as the lamellae follow a sinusoidal movement during the oscillation—and filter more strongly than at the points of maximum speed. The arrangement of the lamellae is also different: in the state of the art the lamellae run parallel to each other; whereas in the case of the invention they run radially out from the axle. This is the simplest form of the arrangement of the lamellae if it is desired to move away from the known oscillation and use rotating lamellae instead. The lamellae are made of a material that strongly absorbs X-rays, such as tungsten or lead for example.

An advantageous development of the invention provides that the lamellae are borne at their radially inner ends in a common ring which is preferably arranged concentrically around the axle and/or preferably consists of material of high tensile strength. The lamellae are thereby held securely not only at their outer ends, but also at their inner ends by means of a device that is simple to produce; the lamellae then need not all be joined to each other along a line.

A further advantageous development of the invention provides that the mount is annular, which is preferably arranged concentrically around the axle and preferably consists of material of high tensile strength. An annular mount has the advantage that the lamellae can then all be equally long and no imbalance results when the anti-scatter filter is rotated in the case of a concentric arrangement of the mount around the axle. The use of a material of high tensile strength for the mount has the effect that the centrifugal forces which act on the lamellae during the rotation of the anti-scatter filter are safely absorbed at their outer edges.

A further advantageous development of the invention provides that arranged in the mount there are a first plate, which is arranged in front of the lamellae in relation to the X-ray source when the anti-scatter filter is installed in the X-ray inspection system, and/or a second plate, which is arranged behind the lamellae in relation to the X-ray source when the anti-scatter filter is installed in the X-ray inspection system. Through the plate/plates, the lamellae are prevented from shifting in the axial direction; thereby, the mount can be formed more simply at their radially outer ends and the common ring can be formed more simply at their radially inner ends, as these two elements then need not also provide an axial fixing in addition to the radial fixing of the lamellae.

An advantageous development of the invention provides that the first plate and/or the second plate consist of a material that weakly absorbs X-rays, preferably of carbon. By “that weakly absorbs X-rays” is meant for example when a material has an absorption coefficient of <0.3 [1/cm] at 160 keV. As weakly absorbing material generates less scattered radiation in the useful radiation range, a better result is achieved. The material can, of course, also be structured, as any structures present are blurred because of the rapid rotational movement.

The object is also achieved by an anti-scatter double filter with the features of claim 6. The planes spanned by the respective lamellae of each anti-scatter filter are arranged offset relative to each other in order that the lamellae of the two anti-scatter filters do not collide with each other during the rotation, as the two axles are aligned substantially parallel to each other and have a predefinable distance from each other.

The object is also achieved by an X-ray inspection system with the features of claim 7. As the X-ray inspection system according to the invention has a single anti-scatter filter according to the invention or an anti-scatter double filter according to the invention, for the reasons already named above the advantages listed there result analogously. As the axle(s) is/are stationary and highly absorbing, it/they must not be arranged in the beam path, in order not to distort the inspection result. If the two axles of the two anti-scatter filters can be driven in opposite directions, as is the case as a preferred embodiment in an X-ray inspection system according to the invention, the advantage, already mentioned above and stated in more detail in the following paragraph, of preventing a stronger gradient with respect to the absorption results.

An advantageous development of the X-ray inspection system according to the invention provides that a manipulator for moving the inspection part is arranged in the compartment for introducing an inspection part. Thereby, not only can a positioning of the inspection part be carried out by hand, but more advanced applications can thus be carried out than is the case with a positioning by hand.

The object is also achieved by the operation of an X-ray inspection system with the features of claim 9. At an angular velocity according to the invention of at least 120 revolutions per minute in conjunction with the integrated measurement over at least 0.1 s, it is achieved that no pattern of the lamella arrangement of the anti-scatter filter(s) is imaged on the X-ray detector.

An advantageous development of the operation according to the invention provides that the two axles of the two anti-scatter filters are rotated at separately predefinable angular velocities in each case. It is unimportant whether the two axles of the two anti-scatter filters are driven in opposite directions or in the same direction, as the gradients forming because of the rotations are removed by means of a gain correction. The use of such a gain correction is known to a person skilled in the art. This also applies with respect to gradients that are different because of different angular velocities of the two anti-scatter filters. Through the rotation in opposite directions of the two anti-scatter filters at angular velocities that are identical in terms of amount, however, it is achieved that the necessary gain correction of the gradient proves to be smaller. However, a gain correction is still necessary, as the X-ray tube itself also causes a gradient—which is known to a person skilled in the art.

All features, indicated in the dependent claims, of the advantageous developments belong to the invention both by themselves individually in each case and in any desired combinations.

### BRIEF DESCRIPTION OF THE DRAWINGS

The figures show:

FIG. 1 a schematic section through an inspection object to illustrate the formation of scattered radiation and the representation of the imaging X-radiation,

FIG. 2 a schematic side view of an embodiment example of an X-ray system according to the invention,

FIG. 3 a schematic view of the anti-scatter filter of FIG. 2 seen from the left as well as from above on a reduced scale, and

FIG. 4 a schematic view of an anti-scatter double filter according to the invention seen from the same direction as the anti-scatter filter of the upper part of FIG. 3.

### DETAILED DESCRIPTION OF THE INVENTION

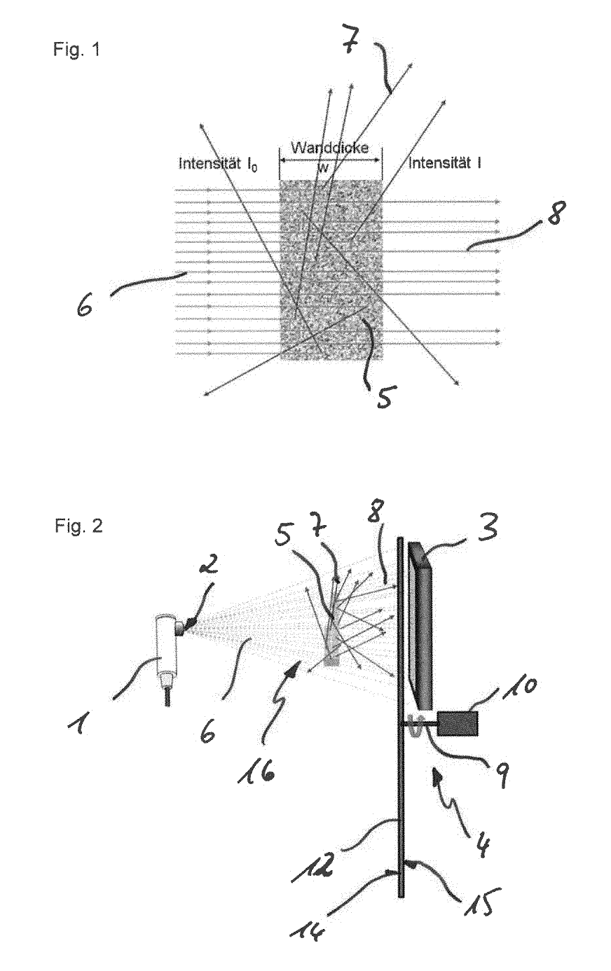

FIG. 1 is a visualization of the formation of the scattered radiation 7 and for the imaging X-radiation 8 in an inspection part 5, as has already been described briefly above in the introduction.

In the centre, an inspection part 5 is represented schematically with a uniform (only by way of example) wall thickness W. This inspection part 5 is struck, from the left, by entering X-radiation 6 with the intensity 10 coming from a focal spot 2 of an X-ray source 1 (see FIG. 2). The inspection part 5 is to be seen as a new radiation source which emits X-radiation in all directions. The portion of this X-radiation which is not radiated in the same direction as the entering X-radiation 6 is scattered radiation 7. The X-radiation (which is radiated in the same direction as the entering X-radiation 6) is called imaging X-radiation 8 and has an intensity I which is reduced compared with the intensity 10 of the entering X-radiation 6 by a factor which depends on the wall thickness W and the material of the inspection part 5. Only the imaging X-radiation 8 is of interest for the imaging of the inspection part.

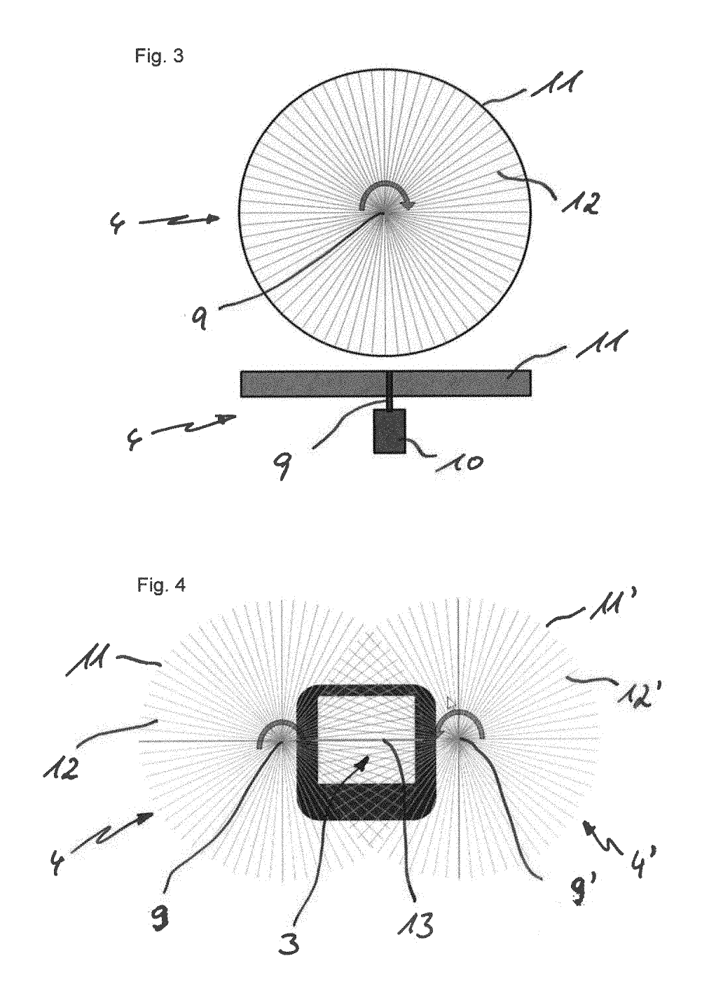

FIG. 2 shows a schematic side view of an embodiment example of an X-ray inspection system according to the invention. FIG. 3 shows the embodiment example represented in FIG. 2 of an anti-scatter filter 4 according to the invention seen from the left (upper part of FIG. 3) and seen from above (lower part of FIG. 3) with reference to FIG. 2.

FIG. 2 shows an X-ray source 1, which emits X-radiation from its focal spot 2. The entering X-radiation 6 penetrates the inspection part 5 and there generates scattered radiation 7 as well as imaging X-radiation 8, as was described above in relation to FIG. 1. The imaging X-radiation 8 then strikes an X-ray detector 3. The inspection part 5 is arranged in a compartment 16 between the X-ray source 1 and the X-ray detector 3. It can be brought into the desired position either by hand or by means of a manipulator (neither represented as such processes are well known to a person skilled in the art).

The anti-scatter filter 4 according to the invention is arranged in the beam path of the imaging X-radiation 8. It rotates about an axle 9, which is driven by a drive motor 10, clockwise seen from the direction of the X-ray source 1 (easily recognizable in the upper part of FIG. 3 with reference to the arrow represented there).

The more detailed design of the anti-scatter filter 4 is represented in FIG. 3. There, in the upper part, the anti-scatter filter 4 is shown from the direction of the X-ray source. Starting from the axle 9, a plurality of lamellae 12 which are arranged in a circular mount 11 at their outer ends extend radially. The mount 11 acts as an outer bearing for the lamellae 12 in the radial direction, in particular when the anti-scatter filter 4 is rotated about the axle 9. As the mount 11 is not in the beam path during the entire rotation of the anti-scatter filter 4, the material from which it is manufactured can be chosen independently of its properties in relation to X-radiation. It merely needs to be capable of absorbing the radial forces (centrifugal forces) which emanate from the lamellae 12 during the rotation. For this, the mount must consist of a material of high tensile strength, for example of steel or carbon. At the same time, the material is preferably not too heavy, in order to keep the centrifugal forces forming thereby low. The lamellae 12 are identical sheets made of a material that strongly absorbs X-rays, such as for example of tungsten, lead or a tungsten-copper alloy. The surfaces of the sheets are aligned perpendicular to the surface of the detector 3. It is thereby achieved that the scattered radiation 7, which is desired to cross the anti-scatter filter 4, is filtered away through the sheets of the lamellae 12, which consist of material that absorbs X-radiation well.

In order that the lamellae 12 do not also shift in the axial direction relative to the axle 9, a first plate 14 and a second plate 15 are attached in the mount 11 by means of joining techniques known to a person skilled in the art for example circumferential inner grooves on the mount 11, in which in each case the edge of a plate 14, 15 is borne. The first plate 14 is arranged in front of the lamellae 12 in relation to the X-ray source 1 and the second plate 15 is arranged behind it. If, at the radially inner ends of the lamellae 12, these are borne in a common ring (not represented in the figures), a radial fixing of the lamellae 12 is achieved by this ring. The two plates 14, 15 are then joined to the ring identically to or by a different joining technique from that used to join their outer boundaries to the mount 11. The plates 14, 15 are made of a material that weakly absorbs X-rays, for example carbon, in order to produce as little scattered radiation as possible and to cause only small intensity losses in the imaging X-radiation 8—as the plates, unlike the mount 11, are located in the beam path. The ring on the contrary—like the mount 11—is always located outside the beam path and should be made of a material which can absorb the expansion forces of the lamellae 12 due to the centrifugal force. It must be correspondingly rigid, inelastic and of high tensile strength; the properties with respect to X-radiation are unimportant here. In contrast to the mount 11, the weight of the material of the ring is not crucial, as it is located at only a small distance from the axle 9 and the centrifugal forces forming during the rotation are much lower than in the case of the mount, which is located at a great distance from the axle 9. For example, steel or carbon also come into consideration here as materials.

In the embodiment example represented, the sheets of the lamellae 12 are not held at their inner ends in the region of the axle 9 by a ring, but they are all securely joined to each other (for example are glued or welded to each other).

During the inspection process, thus during the operation of the X-ray inspection system, the anti-scatter filter 4 is rotated about the axle 9 at a predefinable angular velocity. This angular velocity is adjusted to the readout rate of the X-ray detector 3. This must be great enough that no pattern of the lamellae 12 is imaged on the X-ray detector 3 during integration over a predefined period of time in which the inspection part 5 is inspected. This is achieved for example in the case of an X-ray detector 3 with a frame time (internal readout time) of 0.1 seconds—which corresponds to a readout rate of 10 Hz or 10 fps (frames per second)—at an angular velocity of 120 revolutions per minute.

The anti-scatter filter 4 is arranged in relation to the X-ray detector 3 such that the axle 9 lies outside the X-ray detector 3 and the X-ray detector (more precisely: its active region) is completely covered by the lamellae 12. Thus, no region of the X-ray detector 3 is covered by the region of the axle 9 in which the imaging X-radiation 8 would always—even when the anti-scatter filter 4 is rotated—be absorbed by the lamellae 12; at the same time the same also applies with respect to the mount 11, which would always cover a region of the X-ray detector 3 in the shape of a segment of a circle even in the case of a rotation.

When an inspection part 5 is inspected in an X-ray inspection system with an anti-scatter filter 4 represented in FIGS. 2 and 3, however, there is more and denser material close to the axle 9 because of the arrangement of the lamellae 12, which lie closer to each other inwardly. Conversely, the filter effect on the other side is reduced. A disruptive gradient would thereby be visible in the image obtained in the X-ray detector 3 in the radial direction without gain correction. However, this gradient is corrected out by the gain correction. The disadvantage of the gradient is an inhomogeneous image quality, thus the signal-to-noise ratio is poorer in the darker regions before the gain correction.

In order to counteract these gradients, an anti-scatter double filter according to FIG. 4 is used. This has two identical anti-scatter filters 4, 4′, the respective axles 9, 9′ of which are aligned parallel to each other (and perpendicular to the surface of the X-ray detector 3). The two axles 9, 9′ are located—as in the embodiment example of FIGS. 2 and 3—outside the X-ray detector 3. The distance 13 between them is chosen such that the mounts 11, 11′ of the two anti-scatter filters 4, 4′ are arranged outside the X-ray detector 3 and the entire X-ray detector 3 is completely covered both by the first lamellae 12 of the first anti-scatter filter 4 and by the second lamellae 12′ of the second anti-scatter filter 4′. The distance 13 between first axle 9 of the first anti-scatter filter 4 and second axle 9′ of the second anti-scatter filter 4′ is aligned such that it runs horizontally in the centre of the X-ray detector 3 in relation to its height. A maximum covering is thereby achieved, or the necessary diameter of the plates 14, 15 is minimal.

In operation of the X-ray system according to FIG. 4 during the inspection of the inspection part 5 (see FIG. 2), the two anti-scatter filters 4, 4′ rotate at the same angular velocity but in opposite directions: the first anti-scatter filter 4—as in FIGS. 2 and 3 as well—rotates in a clockwise direction and the second anti-scatter filter 4′ rotates in an anti-clockwise direction, as is represented by the two arrows. The gradients caused by the two anti-scatter filters 4, 4′ are thereby compensated for in large part; the remaining compensation is achieved by means of a gain correction—known to a person skilled in the art and already addressed above.

While the foregoing is directed to embodiments of the present invention, other and further embodiments and advantages of the invention can be envisioned by those of ordinary skill in the art based on this description without departing from the basic scope of the invention, which is to be determined by the claims that follow.

### LIST OF REFERENCE NUMBERS

1 X-ray source
2 focal spot
3 detector
4 (first) anti-scatter filter
4′ second anti-scatter filter
5 inspection part
6 entering X-radiation
7 scattered radiation
8 imaging X-radiation
9 (first) axle
9′ second axle
10 drive motor
11 (first) mount
11′ second mount
12 (first) lamellae
12′ second lamellae
13 distance between the axles
14 first plate
15 second plate
16 compartment for inspection part
W wall thickness

1. An anti-scatter filter (4) for an X-ray inspection system which has an X-ray source (2) with a main beam direction, an X-ray detector (3) and a compartment (16) for introducing an inspection part (5) between X-ray source (2) and X-ray detector (3),
wherein the anti-scatter filter (4) is rotatable about an axle (9) which can be driven by a drive motor (10),
wherein the axle (9), in the installed state in the X-ray inspection system; is substantially perpendicular to the surface of the X-ray detector (3),
wherein the anti-scatter filter (4) has several sheet-like lamellae (12) made of a material that strongly absorbs X-rays,
wherein the surfaces of the lamellae (12) are aligned substantially parallel to the main beam direction,
wherein the lamellae (12) extend radially out from the axle (9),
wherein the lamellae (9) are borne in a common mount (11) at their radially outer ends.

2. The anti-scatter filter (4) according to claim 1, wherein the lamellae (12) are borne at their radially inner ends in a common ring which is preferably arranged concentrically around the axle (9) and/or preferably consists of material of high tensile strength.

3. The anti-scatter filter (4) according to claim, wherein the mount (11) is annular, which is preferably arranged concentrically around the axle (9) and preferably consists of material of high tensile strength.

4. The anti-scatter filter (4) according to claim, wherein arranged in the mount (11) there are a first plate (14), which is arranged in front of the lamellae (12) in relation to the X-ray source (1) when the anti-scatter filter (4) is installed in the X-ray inspection system, and/or a second plate (15), which is arranged behind the lamellae (12) in relation to the X-ray source (1) when the anti-scatter filter (4) is installed in the X-ray inspection system.

5. The anti-scatter filter (4) according to claim 4, wherein the first plate (14) and/or the second plate (15) consist of a material that weakly absorbs X-rays, in particular of carbon.

6. An anti-scatter double filter, which has a first anti-scatter filter (4) and a second anti-scatter filter (4′), wherein each of these two anti-scatter filters (4, 4′) is formed according to claim 1, wherein the two axles (9, 9′) are aligned substantially parallel to each other and have a predefinable distance (13) from each other and the planes spanned by the respective lamellae (12) of each anti-scatter filter (4, 4′) are arranged offset relative to each other.

7. An X-ray inspection system with an X-ray source (1) with a main beam direction, an X-ray detector (3) and a compartment (16) for introducing an inspection part (5) between X-ray source (1) and X-ray detector (3), as well as with an anti-scatter filter (4, 4′) or an anti-scatter double filter according to claim 6,
wherein the axle (9) of the anti-scatter filter (4) or the axles (9, 9′) of the two anti-scatter filters (4, 4′) is/are substantially perpendicular to the surface of the X-ray detector (3) and is/are arranged outside the X-ray detector (3).

8. The X-ray inspection system according to claim 7, wherein a manipulator for moving the inspection part (5) is arranged in the compartment (16) for introducing an inspection part (5).

9. An operation of an X-ray inspection system according to claim 7, wherein during the inspection of an inspection part (5) the single axle (9) or the two axles (9, 9′) is/are driven at an angular velocity of at least 120 revolutions per minute and the inspection is effected over a period of time of at least 0.1 second.

10. The operation of an X-ray inspection system according to claim 9, wherein the two axles (9, 9′) of the two anti-scatter filters (4, 4′) are rotated at separately predefinable angular velocities in each case.
